(19) United States
(12) Patent Application Publication
(10) Pub. No.: US 2006/0280997 A1
(43) Pub. Date: Dec. 14, 2006

(54) PtNi based supported electrocatalyst for proton exchange membrane fuel cell having CO tolerance

(75) Inventors: Duck-young Yoo, Seoul (KR); Youngmin Liang, Daillan (CN); Yanling Qiu, Daillan (CN); Zhigun Tian, Daillan (CN); Huamin Zhang, Daillan (CN); Baolian Yi, Daillan (CN)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/371,080

(22) Filed: Mar. 9, 2006

(30) Foreign Application Priority Data
Mar. 9, 2005 (CN) 200510045989.9
Feb. 21, 2006 (KR) 2006-16673

(51) Int. Cl. H01M 4/92; B01J 23/42; B01J 23/755

(52) U.S. Cl. 429/40; 429/44; 502/326

(57) ABSTRACT

A supported electrochemical catalyst used to produce a proton exchange membrane fuel cell, the supported anode catalyst including an electrically conductive support and Pt/Ni based alloy nanoparticles. The supported electrochemical catalyst can be synthesized using an improved microwave-irradiated polyol (IMIP) method, and a heat treating method while being subjected to a reduction reaction under an inert environment. The catalyst exhibits an improved carbon monoxide (CO) tolerance and high activity with respect to a hydrogen oxidation reaction. In addition, the manufacturing method for the supported electrochemical catalyst is simple, environmentally friendly, quick, and inexpensive.

### CROSS-REFERENCE TO RELATED APPLICATIONS

This application claims the benefit of Chinese Patent Application No. 200510045989.9, filed Mar. 9, 2005, in the Chinese Intellectual Property Office, and Korean Patent Application No. 2006-16673, filed Feb. 21, 2006, in the Korean Intellectual Property Office, the entire disclosures of which are incorporated herein by reference.

### BACKGROUND OF THE INVENTION

1. Field of the Invention

Aspects of the present invention relate to a proton exchange membrane fuel cell (PEFC), and more particularly, to a highly active PtNi based supported electrochemical catalyst that is used in a PEFC.

2. Description of the Related Art

Proton exchange membrane fuel cells (PEFCs) are being developed as a power source of mobile applications and draw much attention because they are lightweight and environmentally friendly and have a high energy density and a quick start-up. Over the past few decades, a number of technical problems related to PEFCs were solved and now PEFCs are about to be commercialized. However, there are still a few problems to be solved prior to the commercialization of PEFCs. For example, a carbon monoxide (CO) impurity, which is generated when natural gas, methanol or other liquid fuels are modified and is contained in hydrogen in amounts as small as a few ppm, severely poisons a Pt electrochemical catalyst supported by carbon having a large surface area which is very active with respect to a hydrogen oxidation reaction (HOR) of hydrogen generated in an anode of a PEFC. Such a CO related problem results in reduced power output and low energy efficiency. Therefore, research into a highly active, CO tolerant electrochemical catalyst has been actively carried out and significant achievements have been recently obtained.

M. Gotz et al. teaches that PtRu/C has great CO tolerance (M. Gotz et al., “Binary and ternary anode catalyst formulations including the elements W, Sn and Mo for PEMFCs operated on methanol or reformate gas,” Electrochimica Acta., 43(1998) 3637).

Park Gyeong-won et al. teaches that PtRuNi/C is more active than PtRu/C (Park Gyeong-won et al., “Chemical and effects of Ni in Pt/Ni and Pt/Ru/Ni alloy nanoparticles in methanol electrooxidation,” J. Phys. Chem. B, 106(2002) 1869).

However, such an improved effect due to the development of a CO tolerant catalyst is insufficient to commercialize PEFCs, and thus there is still a need to develop an electrochemical catalyst that is highly active with respect to an HOR even in the presence of CO.

A CO tolerant electrochemical catalyst can be obtained by minimizing the CO poison or by decreasing CO adsorbed to an active site to a lowest level possible and maximizing the number of hydrogen oxidation reaction sites.

Chinese Patent CN1171670C discloses a method of preparing a precious metal supported electrochemical catalyst that is highly loaded with precious metal. However, since this method uses convection heating, a slow non-uniform reaction occurs.

U.S. Pat. No. 5,068,161 discloses a method of preparing a Pt based alloy catalyst in which the concentration of Pt is relatively high. However, this method requires a long manufacturing time.

Recently, catalysts are prepared using microwaves. That is, an oscillating electromagnetic interaction with a bipolar moment of a molecule induces rapid and uniform heat. Accordingly, the resultant catalyst using a microwave oven is very reactive and has small particles having a narrow particle size distribution.

Chinese Patent CN1395335A discloses a method of preparing a supported electrochemical catalyst through irradiation of microwaves. This method is useful to produce small uniform nanoparticles, but the chemical agents used, such as formaldehyde, sodium borohydride, or the like, are harmful and corrosive.

Japanese Patent No. 2003-286509 (Reference 6) discloses a method of preparing a catalyst using microwaves. This method, however, uses a stabilizer, such as polyvinylpyrrolidone (PVP), polyvinyl alcohol (PVA), or triphenylphosphine (PPh₃).

### SUMMARY OF THE INVENTION

An aspect of the present invention provides a PtNi based supported electrochemical catalyst having an improved CO tolerance. The preparation process for the catalyst is simple and can be quickly completed, wherein an active component is highly loaded. In addition, a solvent, a reductant, and a dispersant used in this process are safe and environmentally friendly.

The supported electrochemical catalyst according to an embodiment of the present invention, includes at least Pt and Ni in an atomic ratio of 1:1. The supported electrochemical catalyst contains a metallic component of 30 wt % to 80 wt %.

The supported electrochemical catalyst according to an embodiment of the present invention, exhibits excellent CO tolerance with respect to a hydrogen oxidation reaction even in the presence of 100 ppm of CO.

Such an improved CO tolerance may result because of several reasons. For example, Pt electrons are affected through alloying of Pt with Ni and/or other metals, and thus CO has less influence on active sites of the alloyed Pt. Furthermore, CO adsorbed to an active site is effectively oxidized into CO₂. These effects can significantly improve catalyst active sites of a hydrogen oxidation reaction.

According to an aspect of the invention, in order to load metal on a support, a salt of the metal is dissolved in a solvent and then the resultant mixture is homogeneously mixed with a slurry including the support in another solvent. The pH of the resultant suspended solution is controlled to 10 to 14 and then heated in a microwave oven. A solid material is separated from the heated solution and dried, thereby obtaining a nanocomposite. The nanocomposite is reduced through a heat treatment performed under an inert gas atmosphere including a reducing material.

According to an aspect of the present invention, there is provided a PtNi based supported electrochemical catalyst used to produce a proton exchange membrane fuel cell, that is, a catalyst supported by an electrically conductive support, wherein the PtNi based catalyst contains at least Pt and Ni in an atomic ratio of 1:0.9 to 1:1.1 and the amount of the catalyst is in the range of 30 wt % to 80 wt % based on the entire weight amount of the supported electrochemical catalyst.

According to an aspect of the present invention, there is provided a method of preparing a supported electrochemical catalyst used to produce a fuel cell, the method including: dissolving a metallic compound with a solvent to prepare solution A; mixing a dispersant and 20 mL/gₛᵤₚₚₒᵣₜ to 100 mL/gₛᵤₚₚₒᵣₜ of an electrically conductive support to prepare slurry B; mixing the solution A and the slurry B and adding a salt of alkali metal or alkali earth metal to the resultant mixture such that pH of the mixture is in the range of 10 to 14, thereby preparing slurry C; continuously or discontinuously heating the slurry C using a microwave oven, cooling the heated slurry C, and adding an acid to the cooled slurry such that pH of the slurry is 6 or less, thereby preparing slurry D; separating a solid phase from the slurry D, cleaning the separated solid phase using water or alcohol until pH of the separated solid phase is 7 and any chloride ions are removed, and drying the resultant solid phase, to prepare powder E; and heat treating the powder E at 300° C. to 800° C. while providing a reducing gas.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a transmission electron microscopy (TEM) image of a Pt₁Ru₁Ni₁/C supported electrochemical catalyst in an atomic ratio of 1:1:1 having a metallic component of 40 wt % according to an embodiment of the present invention;

FIG. 2 is an X-ray diffraction (XRD) graph of a Pt₁Ru₁Ni₁/C supported electrochemical catalyst in an atomic ratio of 1:1:1 having a metallic component of 40 wt % according to an embodiment of the present invention;

FIG. 3 is a graph comparing performance of unit cells including catalysts prepared, respectively, according to Example 1 and Comparative Example 1;

FIG. 4 is a graph comparing performance of unit cells including catalysts prepared, respectively, according to Example 2 and Comparative Example 1;

FIG. 5 is a graph comparing performance of unit cells including catalysts prepared, respectively, according to Example 3 and Comparative Example 1; and

FIG. 6 is a graph of performance of a unit cell including a catalyst prepared according to Example 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A PtNi based supported electrochemical catalyst used to produce a proton exchange membrane fuel cell (PEFC) according to an embodiment of the present invention, includes an electrically conductive support and a catalyst supported on the electrically conductive support. The catalyst contains at least Pt and Ni in an atomic ratio of 1:0.9 to 1:1.1 and the amount of the metal based catalyst is in the range of 30 wt % to 80 wt % based on the entire amount of the supported electrochemical catalyst.

The catalyst may further include at least one metallic component selected from Group IIIB, Group IVB, Group VIB, Group VIIB, Group VIII, and Group IB. Specifically, the metallic component may be selected from the group ruthenium, rhodium, palladium, iridium, osmium, gold, silver, titanium, molybdenum, tungsten, iron, rhenium and a combination thereof, according to an embodiment of the invention.

A method of preparing a supported electrochemical catalyst according to an embodiment of the present invention includes: dissolving a metallic compound with a solvent to prepare solution A; mixing a dispersant and 20 mL/gₛᵤₚₚₒᵣₜ to 100 mL/gₛᵤₚₚₒᵣₜ of an electrically conductive support to prepare slurry B; mixing the solution A and the slurry B and adding a salt of alkali metal or alkali earth metal to the resultant mixture such that pH of the mixture is in the range of 10 to 14, thereby preparing slurry C; continuously or discontinuously heating the slurry C using a microwave oven, cooling the heated slurry C, and adding an acid to the cooled slurry such that pH of the slurry is 6 or less, thereby preparing slurry D; separating a solid phase from the slurry D, cleaning the separated solid phase using water or alcohol until pH of the separated solid phase is 7 and chloride ions are removed, and drying the resultant solid phase, to prepare powder E; and heat treating the powder E at 300° C. to 800° C. while providing a reducing gas.

According to an aspect of the invention, the heat treated product is cooled to room temperature to attain the supported electrochemical catalyst.

A supported electrochemical catalyst according to an embodiment of the present invention is formed of a conductive support and a catalyst. The catalyst includes at least Pt and Ni. The combined amount of Pt and Ni is at least 30 wt % based on the amount of the supported electrochemical catalyst. The catalyst according to an embodiment of the present invention can further include at least one metallic component selected from Group IIIB, Group IVB, Group VIB, Group VIIB, Group VIII, and Group IB (of a predetermined amount.) For example, the PtNi catalyst can further include at least one metallic component selected from ruthenium, rhodium, palladium, iridium, osmium, gold, silver, titanium, molybdenum, tungsten, iron, and rhenium. In the supported electrochemical catalyst according to an embodiment of the present invention, the amount of the metallic component is in the range of 30 wt % to 80 wt %, for example, 30 wt % to 60 wt %. When the amount of the metallic component is less than 30 wt %, the activity is insufficient. On the other hand, when the amount of the metallic component is greater than 80 wt %, the manufacturing costs increase. The total amount of Pt and Ni can be 30 wt % or greater based on the total weight of the supported electrochemical catalyst.

In the method of preparing a supported electrochemical catalyst according to an embodiment of the present invention, the metallic compound, which is water soluble, includes at least one compound selected from a nitrate, sulfate, acetate, or halide of a metal that will be loaded. The electrically conductive support is graphitized carbon black, carbon nanotube, carbon nanofiber, aerogel carbon, and/or mesocarbon. The solvent is water, a primary C₂-C₈ alcohol group, a secondary C₂-C₈ alcohol group, and/or a tertiary C₂-C₈ alcohol group. The dispersant is water, a primary C₂-C₈ alcohol group, a secondary C₂-C₈ alcohol group, a tertiary C₂-C₈ alcohol group, and/or a carboxylic acid salt of these.

According to an aspect of the present invention, the salt of alkali metal or alkali earth metal is a hydrate, carbonate, or bicarbonate of alkali metal or alkali earth metal.

In the present embodiment, the microwave has a frequency of 1 kHz to 50 kHz, for example 2 kHz to 20 kHz, and a power output of 400 W to 1000 W, for example 500 W to 800 W. When the frequency of the microwave is less than 1 kHz, the heating effect is too low and thus the microwave heating is insufficiently performed. On the other hand, when the frequency of the microwave is greater than 50 kHz, microwave heating is excessive and thus metal particles may be fused.

According to an aspect of the present invention, the acid can be a hydrochloric acid, an oxalic acid, an acetic acid, a sulfuric acid, or a nitric acid, but is not limited thereto.

According to an aspect of the present invention, the microwave heating can be performed for 1 minute to 30 minutes. The microwave heating time can be properly selected according to the power output of the microwave.

According to an aspect of the present invention, the reducing gas includes a reducing component of 0.5 volume % to 10 volume %, for example 1 volume % to 5 volume %. When the amount of the reducing component is less than 0.5 volume %, insufficient reduction of the metallic component occurs and thus the amount of the active metallic catalyst particles produced is decreased. On the other hand, when the amount of the reducing component is greater than 10 volume %, the reduction reaction is excessive and thus the metallic catalyst produced has too large a particle size. The reducing gas can be a hydrogen gas or a methane gas. In other embodiments, the reducing gas may further include an inert gas, such as nitrogen gas or argon gas.

The heat treating can be performed for 1 hour to 8 hours, according to an embodiment of the invention. When the heat treating time is less than 1 hour, the heat treatment is insufficient and thus sufficient catalyst reduction cannot be obtained. On the other hand, when the heat treating time is greater than 8 hours, the reduction reaction is excessive and thus the metallic catalyst particle becomes too large. In addition, when the heat treatment temperature is less than 300° C., the catalyst may be insufficiently reduced. On the other hand, when the heat treatment temperature is greater than 800° C., the particle size of the catalyst metal particle is too large.

### EXAMPLE 1

### Pt₁Ru₁Ni₁ Supported Electrochemical Catalyst

1 g of Vulcan XC-72 was added to 100 mL of 95 volume % ethyleneglycol aqueous solution and the resultant solution was stirred to prepare slurry A. 12.4 mL of a hexachloroplatinic acid solution in ethyleneglycol (29.6 mgPt/mL), 51.35 mL of a ruthenium (III) chloride solution in ethyleneglycol (3.7 mgRu/mL), and 11 mL of a nickel nitrate aqueous solution (10 mgNi/mL) were mixed and the resultant mixture was added to the slurry A. 2.5 M NaOH solution in ethyleneglycol was added to the resultant suspended solution to obtain pH 12. A microwave having a frequency of 2.45 kHz and a power output of 700 W was irradiated to the resultant solution of pH 12 for 1.5 minutes. The slurry was cooled to room temperature and a 3M HCl solution was added thereto until pH of the slurry was decreased to 0.5. A solid phase was separated from the slurry, washed until chloride ions were completely removed, and then dried. The dried solid phase was heat treated at 500° C. for 4 hours under a nitrogen atmosphere containing 5 volume % of hydrogen. As a result, a Pt₁Ru₁Ni₁/C supported electrochemical catalyst in an atomic ratio of 1:1:1 containing a metallic component of 40 wt % was obtained.

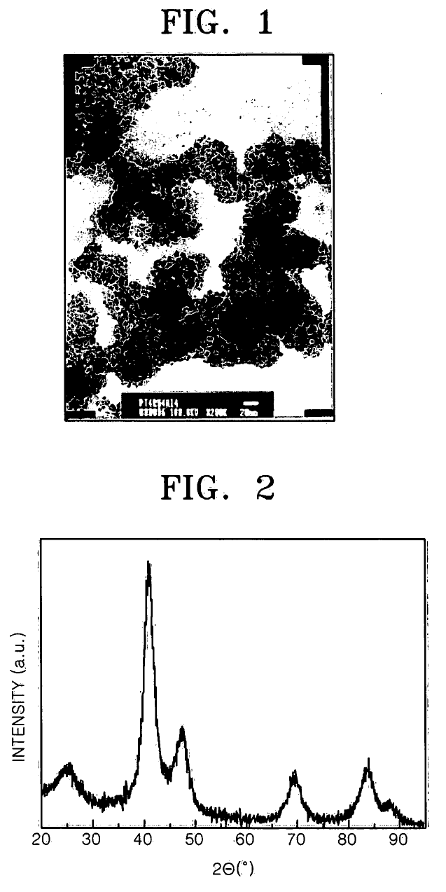

The metal nano composite of the Pt₁Ru₁Ni₁ supported electrochemical catalyst had a small particle size of 3.4 nm and a uniform distribution of the particle size of 2-6 nm, which is shown in FIG. 1.

FIG. 2 is an X-ray diffraction (XRD) graph of the Pt₁Ru₁Ni₁ supported electrochemical catalyst. Referring to FIG. 2, the XRD pattern exhibited a diffraction peak feature of only a Pt face-centered cubic (fcc) structure. That is, diffraction peak features of Ru and Ni were not shown in FIG. 2. A metal cluster had an average particle size of 3.2 nm and a lattice parameter of 3.837 Å, which was smaller than Pt/C (3.918 Å) and PtRu/C (3.884 Å). Such a smaller lattice parameter of the metal cluster implies that the metal nanoparticle is an alloy of Pt, Ru, and Ni. Therefore, it can be assumed that the adsorption force of CO to Pt is decreased and thus the amount of CO covering Pt is correspondingly decreased.

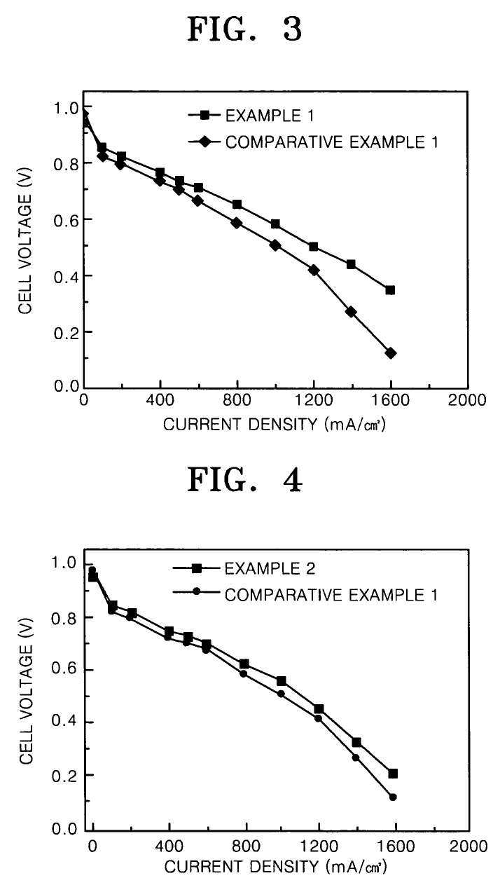

As shown in FIG. 3, the Pt₁Ru₁Ni₁/C supported electrochemical catalyst exhibited high performance. For example, a unit cell including the Pt₁Ru₁Ni₁/C supported electrochemical catalyst exhibited 30 mV and 77 mV higher voltage than a unit cell including a commercially available PtRu/C catalyst, at 500 and 1000 mA/cm², respectively. In addition, a gas chromatography analysis was performed on the Pt₁Ru₁Ni₁/C supported electrochemical catalyst and the commercially available PtRu/C supported catalyst used in Comparative Example 1. As a result, it was found that when the Pt₁Ru₁Ni₁/C supported electrochemical catalyst was used, about 70% of incoming CO was oxidized into CO₂, whereas when the commercially available PtRu/C supported catalyst was used, about 50% of CO was oxidized into CO₂, at a current density of 500 mA/cm².

### COMPARATIVE EXAMPLE 1

A unit cell was produced in the same manner as in Example 1, except that a commercially available PtRu/XC-72 catalyst containing a metallic component of 40 wt % was used. A performance test was performed on the unit cell. During the test, a hydrogen gas containing 100 ppm of CO was used as a fuel, and oxygen was used as an oxidant. The results are shown in FIG. 3. Referring to FIG. 3, the unit cell prepared according to Example 1 exhibited better performance than the unit cell prepared according to Comparative Example 1. This result indicated that the PtRuNi/C supported electrochemical catalyst used in Example 1 had excellent CO tolerance.

### EXAMPLE 2

### PtRuNi Supported Electrochemical Catalyst

1 g of Vulcan XC-72 was added to 100 mL of 95 volume % ethyleneglycol aqueous solution and the resultant solution was stirred to prepare slurry A. 27.86 mL of a hexachloroplatinic acid solution in ethyleneglycol (29.6 mgPt/mL), 115.47 mL of a ruthenium (III) chloride solution in ethyleneglycol (3.7 mgRu/mL), and 24.81 mL of a nickel nitrate aqueous solution (10 mgNi/mL) were mixed and the resultant mixture was added to the slurry A. Sodium carbonate was added to the resultant suspended solution to obtain pH 10. A microwave having a frequency of 2.45 kHz and a power output of 700 W was irradiated to the resultant solution of pH 10 for 15 minutes. The slurry was cooled to room temperature and a 3M HCl solution was added thereto until pH of the slurry was decreased to 0.5. A solid phase was separated from the slurry, washed until all chloride ions were removed, and then dried. The dried solid phase was heat treated at 500° C. for 4 hours under a nitrogen atmosphere containing 5 volume % of hydrogen. As a result, a PtRuNi/C supported electrochemical catalyst in an atomic ratio of 1:1:1 containing a metallic component of 60 wt % was obtained.

A unit cell was produced using the prepared PtRuNi/C supported electrochemical catalyst as a cathode catalyst. Then, a performance test was performed on the unit cell using a hydrogen fuel containing 100 ppm of CO. The same performance test was performed on the unit cell produced according to Comparative Example 1. These results are shown in FIG. 4. Referring to FIG. 4, the catalyst prepared according to Example 2 exhibited better performance than the catalyst prepared according to Comparative Example 1.

### EXAMPLE 3

### Pt₁Ni₁Ir₂ Supported Electrochemical Catalyst

1 g of Vulcan XC-72 was added to 100 mL of deionized water and the resultant solution was stirred to prepare slurry A. 6.89 mL of a solution prepared by dissolving a hexachloroplatinic acid in ethyleneglycol (29.6 mgPVmL), 11.48 mL of a Iridium potassium chloride acid solution in ethyleneglycol (35 mgIr/mL), and 6.13 mL of a nickel nitrate aqueous solution (10 mgNi/mL) were mixed and the resultant mixture was added to the slurry A. NaOH was added to the resultant suspended solution to obtain pH 12. A microwave having a frequency of 48.2 kHz and a power output of 400 W was irradiated to the resultant solution of pH 12 for 30 minutes. The slurry was cooled to room temperature and a 3M HCl solution was added thereto until pH of the slurry was decreased to 2. A solid phase was separated from the slurry, washed until all chloride ions were removed, and then dried. The dried solid phase was heat treated at 600° C. for 3 hours under a nitrogen atmosphere containing 0.5 volume % of hydrogen. As a result, a Pt₁Ni₁Ir₂/C supported electrochemical catalyst in an atomic ratio of 1:1:2 containing a metallic component of 40 wt % was obtained.

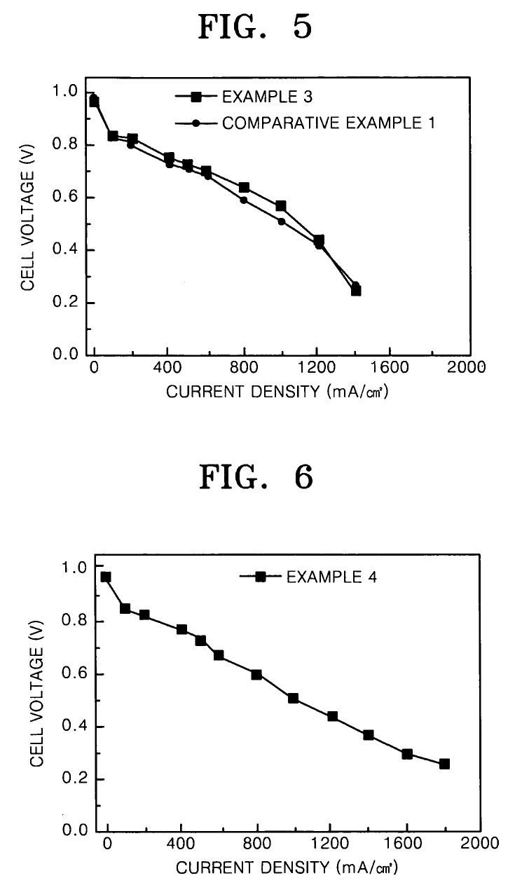

A unit cell was produced using the prepared Pt₁Ni₁Ir₂/C supported electrocatalyst as an anode catalyst. Then, a performance test was performed on the unit cell using a hydrogen fuel containing 100 ppm of CO. The same performance test was performed on the unit cell produced according to Comparative Example 1. These results are shown in FIG. 5. Referring to FIG. 5, the catalyst prepared according to Example 3 exhibited better performance than the catalyst prepared according to Comparative Example 1 except at the highest current density of 1500 mA/cm².

### EXAMPLE 4

### PtNi Supported Electrochemical Catalyst

1 g of Vulcan XC-72 was added to 100 mL of 95 volume % ethyleneglycol aqueous solution and the resultant solution was stirred to prepare slurry A. 11.14 mL of a hexachloroplatinic acid solution in ethyleneglycol (29.6 mgPt/mL) and 9.92 mL of a nickel nitrate aqueous solution (10 mgNi/mL) were mixed and the resultant mixture was added to the slurry A. NaOH was added to the resultant suspended solution to obtain pH 13. A microwave having a frequency of 2.45 kHz and a power output of 700 W was irradiated to the resultant solution of pH 13 for 1.5 minutes. The slurry was cooled to room temperature and a 3M HCl solution was added thereto until pH of the slurry was decreased to 1. A solid phase was separated from the slurry, washed until all chloride ions were removed, and then dried. The dried solid phase was heat treated at 300° C. for 8 hours under a nitrogen atmosphere containing 1 volume % of methane. As a result, a PtNi/C supported electrochemical catalyst in an atomic ratio of 1:1 containing a metallic component of 30 wt % was obtained.

A unit cell was produced using the prepared PtNi/C supported electrochemical catalyst as a cathode catalyst. Then, a performance test was performed on the unit cell using a hydrogen fuel containing 100 ppm of CO. The results are shown in FIG. 6. Referring to FIG. 6, although the amount of the metallic component was as small as 30 wt %, the unit cell exhibited high performance.

### EXAMPLE 5

### Pt₁Ni₁Fe₁ Supported Electrochemical Catalyst

1 g of Vulcan XC-72 was added to 100 mL of 95% ethyleneglycol aqueous solution and the resultant solution was stirred to prepare slurry A. 14.2 mL of a hexachloroplatinic acid solution in ethyleneglycol (29.6 mgPt/mL), 12.03 mL of a ferric nitrate aqueous solution (10 mgFe/mL), and 12.64 mL of a nickel nitrate aqueous solution (10 mgNi/mL) were mixed and the resultant mixture was added to the slurry A. NaOH was added to the resultant suspended solution to obtain pH 12. A microwave having a frequency of 48.2 kHz and a power output of 400 W was irradiated to the resultant solution of pH 12 for 30 minutes. The slurry was cooled to room temperature and a 3M HCl solution was added thereto until pH of the slurry was decreased to 1. A solid phase was separated from the slurry, washed until all chloride ions were removed, and then dried. The dried solid phase was heat treated at 800° C. for 1 hour under a nitrogen atmosphere containing 5 volume % of hydrogen. As a result, a Pt₁Ru₁Fe₁/C supported electrocatalyst in an atomic ratio of 1:1:1 containing a metallic component of 40 wt % was obtained.

### EXAMPLE 6

### Pt₁Ru₁Ni₁ Supported Electrochemical Catalyst

1 g of carbon nanotube (NT) was added to 100 mL of 95% ethyleneglycol aqueous solution and the resultant solution was stirred to prepare slurry A. 12.4 mL of a hexachloroplatinic acid solution in ethyleneglycol (29.6 mgPt/mL), 51.35 mL of a ruthenium (III) chloride solution in ethyleneglycol (3.7 mgRu/mL), and 11 mL of a nickel nitrate aqueous solution (10 mgNi/mL) were mixed and the resultant mixture was added to the slurry A. 2.5 M NaOH dissolved in ethyleneglycol was added to the resultant suspended solution to obtain pH 12. A microwave having a frequency of 2.45 kHz and a power output of 700 W was irradiated to the resultant solution of pH 12 for 1.5 minutes. The slurry was cooled to room temperature and a 3M HCl solution was added thereto until pH of the slurry was decreased to 0.5. A solid phase was separated from the slurry, washed until all chloride ions were removed, and then dried. The dried solid phase was heat treated at 500° C. for 4 hours under a nitrogen atmosphere containing 5 volume % of hydrogen. As a result, a Pt₁Ru₁Ni₁/CNT supported electrochemical catalyst in an atomic ratio of 1:1:1 containing a metallic component of 40 wt % was obtained.

### EXAMPLE 7

### Pt₁Ni₁Pd_{0.5} Supported Electrochemical Catalyst

1 g of Vulcan XC-72 was added to 100 mL of 95 volume % ethyleneglycol aqueous solution and the resultant solution was stirred to prepare slurry A. 14.32 mL of a hexachloroplatinic acid solution in ethyleneglycol (29.6 mgPt/mL), 12.75 mL of a palladium(II) chloride solution in ethyleneglycol (30 mgPd/mL), and 3.85 mL of a nickel nitrate aqueous solution (10 mgNi/mL) were mixed and the resultant mixture was added to the slurry A. NaOH was added to the resultant suspended solution to obtain pH 12. A microwave having a frequency of 2.45 kHz and a power output of 700 W was irradiated to the resultant solution of pH 12 for 15 minutes. The slurry was cooled to room temperature and a 3M HCl solution was added thereto until pH of the slurry was decreased to 0.5. A solid phase was separated from the slurry, washed until all chloride ions were removed, and then dried. The dried solid phase was heat treated at 500° C. for 4 hours under a nitrogen atmosphere containing 10 volume % of methane. As a result, a Pt₁Ni₁Pd_{0.5}/XC-72 supported electrochemical catalyst in an atomic ratio of 1:1:0.5 containing a metallic component of 40 wt % was obtained.

### EXAMPLE 8

### Pt₁Ni₁W₁ Supported Electrochemical Catalyst

1 g of Vulcan XC-72 was added to 100 mL of 95 volume % ethyleneglycol aqueous solution and the resultant solution was stirred to prepare slurry A. 7.53 mL of a hexachloroplatinic acid solution in ethyleneglycol (29.6 mgPt/mL), 1.15 mL of a 1M sodium tungstate aqueous solution, and 6.71 mL of a nickel nitrate aqueous solution (10 mgNi/mL) were mixed and the resultant mixture was added to the slurry A. NaOH was added to the resultant suspended solution to obtain pH 12. A microwave having a frequency of 2.45 kHz and a power output of 700 W was irradiated to the resultant solution of pH 12 for 15 minutes. The slurry was cooled to room temperature and a 3M HCl solution was added thereto until pH of the slurry was decreased to 0.5. A solid phase was separated from the slurry, washed until all chloride ions were removed, and then dried. The dried solid phase was heat treated at 500° C. for 4 hours under a nitrogen atmosphere containing 10 volume % of methane. As a result, a Pt₁Ni₁W₁/XC-72 supported electrochemical catalyst in an atomic ratio of 1:1:1 containing a metallic component of 40 wt % was obtained.

### EXAMPLE 9

### Pt₁Ni₁Au_{0.5} Supported Electrochemical Catalyst

1 g of Vulcan XC-72 was added to 50 mL of 95 volume % ethyleneglycol aqueous solution and the resultant solution was stirred to prepare slurry A. 12.48 mL of a hexachloroplatinic acid solution in ethyleneglycol (29.6 mgPt/mL), 6.22 mL of a chloroauric acid solution in ethyleneglycol (30 mgAu/mL), and 11.11 mL of a nickel nitrate aqueous solution (10 mgNi/mL) were mixed and the resultant mixture was added to the slurry A. 2.5M NaOH dissolved in ethyleneglycol was added to the resultant suspended solution to obtain pH 12. A microwave having a frequency of 2.45 kHz and a power output of 700 W was irradiated to the resultant solution of pH 12 for 15 minutes. The slurry was cooled to room temperature and a 3M HCl solution was added thereto until pH of the slurry was decreased to 0.5. A solid phase was separated from the slurry, washed until all chloride ions were removed, and then dried. The dried solid phase was heat treated at 500° C. for 4 hours under a nitrogen atmosphere containing 5 volume % of hydrogen. As a result, a Pt₁Ni₁Au_{0.5}/XC-72 supported electrochemical catalyst in an atomic ratio of 1:1:0.5 containing a metallic component of 40 wt % was obtained.

### EXAMPLE 10

### Pt₁Ru₁Ni₁ Supported Electrochemical Catalyst

A supported electrochemical catalyst was prepared in the same manner as in Example 1, except that the amount of the metallic component contained therein was 80 wt %.

### EXAMPLE 11

### Pt₁Ru₁Ni₁ Supported Electrochemical Catalyst

A supported electrochemical catalyst was prepared in the same manner as in Example 1, except that the amount of the metallic component contained therein was 30 wt %.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A PtNi based supported electrochemical catalyst used to produce a proton exchange membrane fuel cell, being a catalyst supported by an electrically conductive support, wherein the catalyst comprises at least Pt and Ni in an atomic ratio of 1:0.9 to 1:1.1 and the amount of the catalyst is in the range of 30 wt % to 80 wt % based on the entire amount of the supported electrochemical catalyst.

2. The supported electrochemical catalyst of claim 1, wherein the catalyst further comprises at least one metallic component selected from the group consisting of Group IIIB, Group IVB, Group VIB, Group VIIB, Group VIII, and Group IB.

3. The supported electrochemical catalyst of claim 2, wherein the catalyst is ruthenium, rhodium, palladium, iridium, osmium, gold, silver, titanium, molybdenum, tungsten, iron, rhenium, and a combination thereof.

4. The supported electrochemical catalyst of claim 1, wherein the catalyst is ruthenium, rhodium, palladium, iridium, osmium, gold, silver, titanium, molybdenum, tungsten, iron, rhenium, and a combination thereof.

5. The supported electrochemical catalyst of claim 1, wherein the amount of the catalyst is in the range of 30 wt % to 60 wt % based on the entire amount of the supported electrochemical catalyst.

6. A method of preparing a supported electrochemical catalyst used to produce a fuel cell, the method comprising:
dissolving a metallic compound with a solvent to prepare solution A;
mixing a dispersant and 20 mL/gₛᵤₚₚₒᵣₜ to 100 mL/gₛᵤₚₚₒᵣₜ of an electrically conductive support to prepare slurry B;
mixing the solution A and the slurry B and adding a salt of alkali metal or alkali earth metal to the resultant mixture such that pH of the mixture is in the range of 10 to 14, thereby preparing slurry C;
continuously or discontinuously heating the slurry C using a microwave, cooling the heated slurry C, and adding an acid to the cooled slurry such that pH of the slurry is 6 or less, thereby preparing slurry D;
separating a solid phase from the slurry D, washing the separated solid phase using water or alcohol until pH of the separated solid phase is 7 and all chloride ions are removed, and drying the resultant solid phase, to prepare powder E; and
heat treating the powder E at 300° C. to 800° C. while providing a reducing gas.

7. The method of claim 6, wherein the metallic compound is a nitrate, sulfate, acetate, or halide of the metal.

8. The method of claim 6, wherein the electrically conductive support is graphitized carbon black, carbon nanotube, carbon nanofiber, aerogel carbon, or mesocarbon.

9. The method of claim 6, wherein the solvent is water, a primary C₂-C₈ alcohol group, a secondary C₂-C₈ alcohol group, or a tertiary C₂-C₈ alcohol group.

10. The method of claim 6, wherein the dispersant is water, a primary C₂-C₈ alcohol group, a secondary C₂-C₈ alcohol group, a tertiary C₂-C₈ alcohol group, or a carboxylic acid salt of a combination thereof.

11. The method of claim 6, wherein the microwave has a frequency of 1 kHz to 50 kHz and a power output of 400 W to 1000 W.

12. The method of claim 6, wherein the reducing gas comprises a reducing component of 0.5 volume % to 10 volume %.

13. The method of claim 6, wherein the salt of alkali metal or alkali earth metal is a dihydrate, carbonate, or bicarbonate of alkali metal or alkali earth metal.

14. The method of claim 6, wherein the microwave heating is performed for 1 minute to 30 minutes.

15. The method of claim 6, wherein the acid is a hydrochloric acid, an oxalic acid, an acetic acid, a sulfuric acid, or a nitric acid.

16. The method of claim 6, wherein the heat treating is performed for 1 hour to 8 hours.
